(19) United States
(12) Patent Application Publication
(10) Pub. No.: US 2016/0072108 A1
(43) Pub. Date: Mar. 10, 2016

(54) TRACTION BATTERY FOR AN ELECTRIC MOTOR VEHICLE, AND CORRESPONDING ELECTRIC MOTOR VEHICLE

(71) Applicant: Dr. Ing. h.c. F. Porsche Aktiengesellschaft, Stuttgart (DE)

(72) Inventors: Ralf Keller, Niefern-Oeschelbronn (DE); Eduard Ewert, Karlsruhe (DE); Thomas Fritz, Loechgau (DE)

(21) Appl. No.: 14/844,090

(22) Filed: Sep. 3, 2015

(30) Foreign Application Priority Data
Sep. 10, 2014 (DE) 10 2014 113 023.5

(51) Int. Cl. H01M 2/10; H01M 2/20

(52) U.S. Cl. CPC H01M 2/1077; H01M 2/206; H01M 2220/20

(57) ABSTRACT

A traction battery (10) for an electric motor vehicle has a plurality of battery modules (12, 14) for storing electrical energy and comprises at least one electrically conductive module connector (16) for electrically connecting the battery modules (12, 14). At least two of the battery modules (12, 14) each have a notch (32, 34), and the module connector (16) is guided within the notches (32, 34).

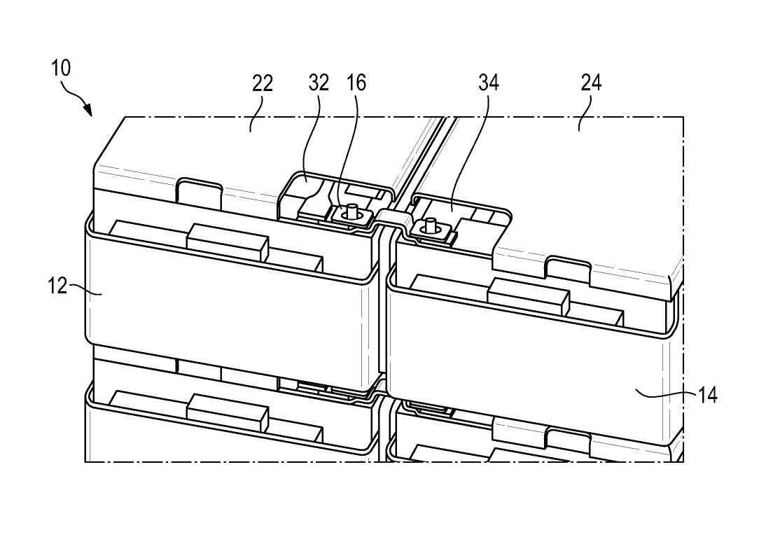

### CROSS REFERENCE TO RELATED APPLICATION

This application claims priority under 35 USC 119 to German Patent Appl. No. 10 2014 113 023.5 filed on Sep. 10, 2014, the entire disclosure of which is incorporated herein by reference.

### BACKGROUND

1. Field of the Invention

The invention relates to a traction battery for an electric motor vehicle and to an electric motor vehicle with such a battery.

2. Description of the Related Art

Electric motor vehicles and hybrid vehicles can be driven by an electric motor and store the electrical energy that is required to drive the vehicles in a traction battery that generally comprises a large number of individual battery modules. Module connectors, such as busbars, usually are guided outside the housing of the individual battery modules to connect the battery modules electrically.

DE 10 2011 013 490 A1 discloses a vehicle having a battery with individual batteries and/or cell assemblies. At least one busbar is arranged on the battery and extends substantially parallel to an axis of the vehicle to combine the current of the individual cells and/or cell assemblies. Each busbar is arranged at a specified minimum distance from at least two opposite circumferential surfaces of the battery.

### SUMMARY

The invention provides a traction battery for an electric motor vehicle, and also provides a corresponding electric motor vehicle. The module connection is designed to accommodate deformations that occur within the battery housing due to a crash. According to the invention, the pole connectors of the battery modules are modified in respect of this scenario so as not to be exposed in the deformation region, but rather are situated in the “shadow” of the battery modules as it were. Therefore, deformations can rarely lead to contact between the usually metallic, and therefore electrically conductive, housing of the traction battery and the module connectors, even in the event of a crash. Thus, vehicle occupants and potential helpers in the case of an accident are not exposed to a risk by a short circuit.

The battery modules can have notches that runs externally on the housing of the battery modules. This design limits structural modifications are limited to the housing, and the actual battery cells of the modules may remain unchanged.

The notches may be adjacent battery modules and face one another to form a continuous cutout in the housings of the adjacent battery modules. This approach permits cost-effective mass production of corresponding traction batteries since each housing can be provided with a substantially identical shape.

Notches in the adjacent battery modules may be along mutually corresponding edges of their flat housing parts. This configuration is compatible with the usual corner position of the electrical poles of a battery module and allows a high degree of stability in comparison to centrally designed apertures and convenient production of the housing parts in question.

The traction battery may have a cuboidal configuration. Thus, the module connector that is recessed behind the outer dimensions of the battery advantageously continues to be protected against contact with the housing for a direction of action of the impact energy that is to be expected for a typical installation position of the traction battery.

A non-conductive sheathing of the module connector can limit the remaining residual risk of a short circuit to a minimum extent. A suitable material for this purpose is plastic. Technical properties of the plastic, such as shapeability, hardness, elasticity, break strength, temperature and thermal deflection resistance and chemical resistance, can be varied within wide limits by virtue of the choice of starting material, production method and admixture of additives.

An exemplary embodiment of the invention is illustrated in the drawing and will be described in greater detail in the text which follows.

### BRIEF DESCRIPTION OF THE DRAWINGS

The single figure shows a perspective view of a traction battery according to one embodiment of the invention.

### DETAILED DESCRIPTION

The figure illustrates the structural design of the traction battery 10 of an electric motor vehicle according to an embodiment of the invention. As shown in the figure, the traction battery 10 is of substantially cuboidal design and comprises a plurality of battery modules for storing electrical energy. Only two adjacent battery modules 12, 14 from among the plurality of battery modules are reproduced in the drawing for reasons of simplicity. Each of these two battery modules 12, 14 is protected by a metallic housing 22, 24, the largely flat top part of the housing covers the face of the respective battery module 12, 14 is at the top in the figure.

Notches 32, 34 are formed along the edges of the top part of the housings 22, 24 of the battery modules 12, 14 that face the viewer. The notches 32, 34 face one another and together form a continuous cutout 32, 34 in the housings 22, 24. A conductive module connector 16 in the form of a busbar is guided within this cutout 32, 34. The module connector 16 connects the negative pole of the battery module 12, which is on the left side in the figure, to the positive pole of the battery module 14, which is on the right side in the figure.

The module connector 16 can be sheathed with plastic as an additional protection against a possible short circuit between the module connector 16 and one of the housings 22, 24, without departing from the scope of the invention.

What is claimed is:

1. A traction battery for an electric motor vehicle, comprising:
a plurality of battery modules for storing electrical energy;
at least one electrically conductive module connector for electrically connecting the battery modules;
at least two of the battery modules having notches; and
the module connector is guided within the notches.

2. The traction battery of claim 1, wherein:
each battery module has a housing for protecting the battery module, and
the notch in one of the battery modules runs into the housing of the battery module.

3. The traction battery of claim 2, wherein:
at least two of the battery modules that have the notches are adjacent, and
the notches in the adjacent battery modules face one another to form a continuous cutout in the housing of the adjacent battery modules.

4. The traction battery of claim 3, wherein:
the housings of the adjacent battery modules each comprise at least one flat housing part, and
the notches in the adjacent battery modules run along mutually corresponding edges of their housing parts.

5. The traction battery of claim 2, wherein the traction battery is cuboidal.

6. The traction battery of claim 2, wherein the module connector has an electrically insulating sheathing.

7. The traction battery of claim 6, wherein the sheathing is plastic.

8. An electric motor vehicle, comprising the traction battery of claim 1.
